(19) United States
(12) Patent Application Publication
(10) Pub. No.: US 2018/0354750 A1
(43) Pub. Date: Dec. 13, 2018

(54) RAIL CLIP FOR ELEVATOR SYSTEMS

(71) Applicants: Nicolas FONTENEAU, Gien (FR); Otis Elevator Company, Farmington, CT (US)

(72) Inventor: Nicolas Fonteneau, Chateauneuf sur Loire (FR)

(21) Appl. No.: 15/777,146

(22) PCT Filed: Nov. 30, 2015
(86) PCT No.: PCT/IB2015/002503

§ 371 Date: May 17, 2018

(51) Int. Cl. B66B 7/02

(52) U.S. Cl. CPC B66B 7/024; B66B 7/02

(57) ABSTRACT

A rail clip assembly for mounting a guide rail section to a support bracket includes a rail clip having a base and an arm extending at an angle to the base. At least one contact assembly is mounted to the rail clip. The contact assembly contacts an adjacent surface of the guide rail section at a point.

### BACKGROUND OF THE DISCLOSURE

This disclosure generally relates to an elevator system, and more particularly, to a rail clip for securing a guide rail of an elevator system to an adjacent support bracket.

In traction elevator systems, the elevator cab is connected to a counterweight unit by hoist ropes and a sheave or pulley system. The cab and the counterweight unit are each typically mounted between a pair of vertically extended guide rails and are arranged to ride along the rails using rollers or guide shoes. The guide rails consist of a plurality of generally T-shaped guide rail sections that are normally erected in sixteen foot lengths and are attached to the building housing the elevator system by support brackets.

In assembly, the base flange of the T-shaped guide rail sections are attached to support brackets by clips so that the blade or web section of each rail points inwardly towards the cab or the counterweight. The guide roller or shoes ride along the blades along with the safeties which are designed to apply a sufficient frictional holding force against the rails to bring the cab to a rapid and safe stop in the event an overspeed condition is sensed. As can be seen, the guide rail sections must be precisely aligned in assembly because they determine the positioning of the elevator in the hoistway and the related positioning of much of the operating equipment.

The clips used to mount the guide rail sections to the support brackets must permit the guide rail sections to shift or move longitudinally in the event the building housing the elevator system settles or the support brackets and/or the building to which the brackets are attached deform non-uniformly due to thermal stresses. The requirements for rail clips are thus not necessarily mutually compatible. The clips must provide sufficient hold force to support not only the rail weight, but also the dynamic load produced when the safeties of the car engage. The clips must also allow the rail to slide vertically in the event the building housing the elevator system settles or there is a difference in thermal expansion between the building and the rails.

### BRIEF DESCRIPTION

According to one embodiment of the disclosure, a rail clip assembly for mounting a guide rail section to a support bracket includes a rail clip having a base and an arm extending at an angle to the base. At least one contact assembly is mounted to the rail clip. The contact assembly contacts an adjacent surface of the guide rail section at a point.

In addition to one or more of the features described above, or as an alternative, in further embodiments the contact assembly includes a contactor arranged in contact with the adjacent surface of the guide rail section. At least a portion of the contactor has a generally spherical shape.

In addition to one or more of the features described above, or as an alternative, in further embodiments the contact assembly includes a biasing mechanism. The contactor is mounted at an end of the biasing mechanism such that the contactor is biased into contact with the adjacent surface of the guide rail section.

In addition to one or more of the features described above, or as an alternative, in further embodiments a fastener couples the contactor to the biasing mechanism. The fastener is configured to adjust a force applied by the contactor to the adjacent surface of the guide rail section.

In addition to one or more of the features described above, or as an alternative, in further embodiments the at least one contact assembly includes a contact assembly extending vertically from the arm.

In addition to one or more of the features described above, or as an alternative, in further embodiments the at least one contact assembly includes a contact assembly extending horizontally from the base.

In addition to one or more of the features described above, or as an alternative, in further embodiments a base plate is configured to mount between the guide rail section and the support bracket.

In addition to one or more of the features described above, or as an alternative, in further embodiments the base plate is configured to contact the guide rail section along a line.

According to another embodiment, a rail assembly is provided including a guide rail section having a base flange and a blade extending perpendicularly from the base flange. The rail assembly additionally includes a support bracket and at least one rail clip assembly for mounting the guide rail section to the support bracket. The at least one rail clip assembly includes a rail clip having a base and an arm extending at an angle to the base and at least one contact assembly mounted to the rail clip. The contact assembly contacts an adjacent surface of the guide rail section at a point.

In addition to one or more of the features described above, or as an alternative, in further embodiments the base of the rail clip extends generally parallel to the blade of the guide rail section and the arm of the rail clip extends outwardly over a portion of the base flange.

In addition to one or more of the features described above, or as an alternative, in further embodiments a gap exists between the arm of the rail clip and an adjacent surface of the base flange.

In addition to one or more of the features described above, or as an alternative, in further embodiments the arm of the rail clip is arranged generally parallel to the adjacent surface of the base flange such that the gap is substantially uniform over a length of the arm.

In addition to one or more of the features described above, or as an alternative, in further embodiments a gap exists between the base of the rail clip and an adjacent surface of the base flange.

In addition to one or more of the features described above, or as an alternative, in further embodiments the at least one contact assembly includes a contact assembly extending vertically from the arm.

In addition to one or more of the features described above, or as an alternative, in further embodiments the at least one contact assembly includes a contact assembly extending horizontally from the base.

In addition to one or more of the features described above, or as an alternative, in further embodiments the contact assembly includes a contactor arranged in contact with the adjacent surface of the guide rail section. At least a portion of the contactor has a generally spherical shape.

In addition to one or more of the features described above, or as an alternative, in further embodiments the contact assembly further includes a biasing mechanism. The contactor is mounted at an end of the biasing mechanism such that the contactor is biased into contact with the adjacent surface of the guide rail section.

In addition to one or more of the features described above, or as an alternative, in further embodiments a fastener couples the contactor to the biasing mechanism and the fastener is configured to adjust a force applied by the contactor to the adjacent surface of the guide rail section.

In addition to one or more of the features described above, or as an alternative, in further embodiments a base plate is configured to mount between the guide rail section and the support bracket.

In addition to one or more of the features described above, or as an alternative, in further embodiments the base plate is configured to contact the guide rail section along a line.

### BRIEF DESCRIPTION OF THE DRAWINGS

The subject matter, which is regarded as the disclosure, is particularly pointed out and distinctly claimed in the claims at the conclusion of the specification.

The foregoing and other features, and advantages of the disclosure are apparent from the following detailed description taken in conjunction with the accompanying drawings in which:

FIG. 1 is a front view of an example of an elevator system;

FIG. 2 is a cross-sectional view of an elevator guide rail and a rail clip assembly according to an embodiment of the disclosure;

FIG. 3 is a top view of an elevator guide rail and a rail clip assembly according to an embodiment of the disclosure;

FIG. 4 is a perspective view of an elevator guide rail and a rail clip assembly according to an embodiment of the disclosure;

FIG. 5 is an exploded perspective view of an elevator guide rail and a rail clip assembly according to an embodiment of the disclosure; and

FIG. 6 is a cross-sectional view of an elevator guide rail and a rail clip assembly according to an embodiment of the disclosure.

The detailed description explains embodiments of the disclosure, together with advantages and features, by way of example with reference to the drawings.

### DETAILED DESCRIPTION OF THE DISCLOSURE

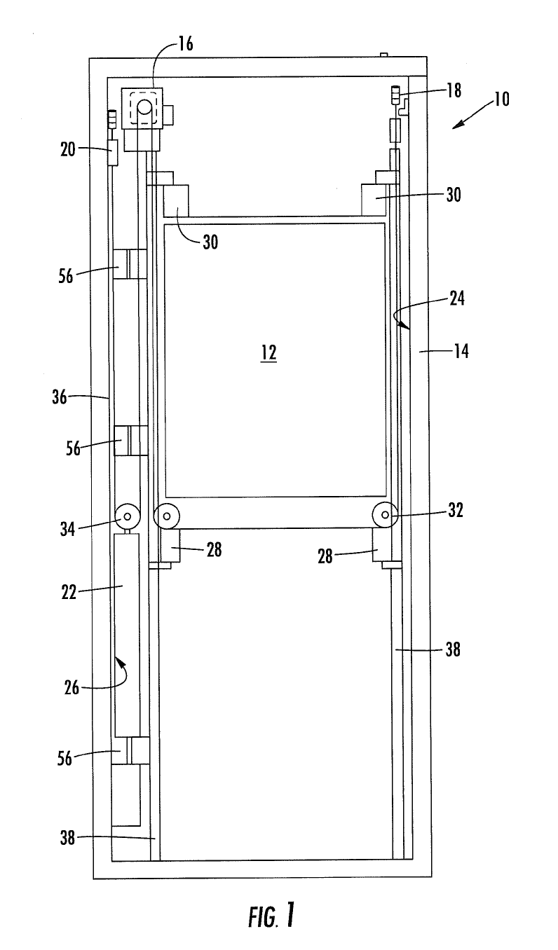

Referring now to FIG. 1, an exemplary elevator system 10 is illustrated. A hoistway 14 includes a car guide rail 38a positioned on an interior wall 24 of the hoistway 14 and a car guide rail 38b mounted to counterweight brackets 56. The counterweight brackets 56 may be mounted to an opposite interior wall 26. Alternatively, the car guide rail 38b may be mounted directly to the opposite interior wall 26, or mounted to the opposite interior wall 26 using separate brackets. The car guide rails 38a, 38b guide vertical movement of an elevator car 12 within the hoistway 14. The elevator car 12 also includes guide assemblies 28, 30 disposed on the top and bottom of the elevator car 12 for maintaining proper alignment of the elevator car 12 as it moves along the car guide rails 38a, 38b.

The counterweight brackets 56 effectively define a space extending the entire height of the hoistway 14 for movement of a counterweight 22. The term counterweight 22 as used herein includes a counterweight assembly that may itself include various components as would be understood by a person skilled in the art. The counterweight 22 moves opposite the elevator car 12 as is known in conventional elevator systems. The counterweight 22 is guided by counterweight guide rails (not shown) mounted within the hoistway 14. The elevator car 12 and counterweight 22 include sheave assemblies 32, 34 that cooperate with one or more tension members 36 and drive machine 16 to raise and lower the elevator car 12. The drive machine 16 in this exemplary embodiment of the disclosure is suited and sized for use with flat traction belts 36. However, an elevator system including a different type of tension member, such as a steel rope for example, is also within the scope of the invention. In the illustrated example, the sheave assemblies 32 are mounted to a base of the elevator car 12. However, the sheave assemblies 32 may be mounted at another location on the elevator car 12 or elsewhere in the system 10 as recognized by a person skilled in the art. The drive machine 16 of the exemplary elevator system 10 is positioned and supported at a mounting location atop at least one of the counterweight guide rails.

By supporting the machine 16 atop the counterweight guide rails the need for a separate machine room, as required in conventional elevator systems, is eliminated. The machine room-less elevator system 10 according to the exemplary embodiment of the disclosure requires much less overhead space in the hoistway 14 than conventionally installed systems, and eliminates the need for a separate machine room. The illustrated elevator system 10 including the roping configuration and hoistway layout are intended as an example only, and the teachings provided herein may be applied to other systems and system configurations.

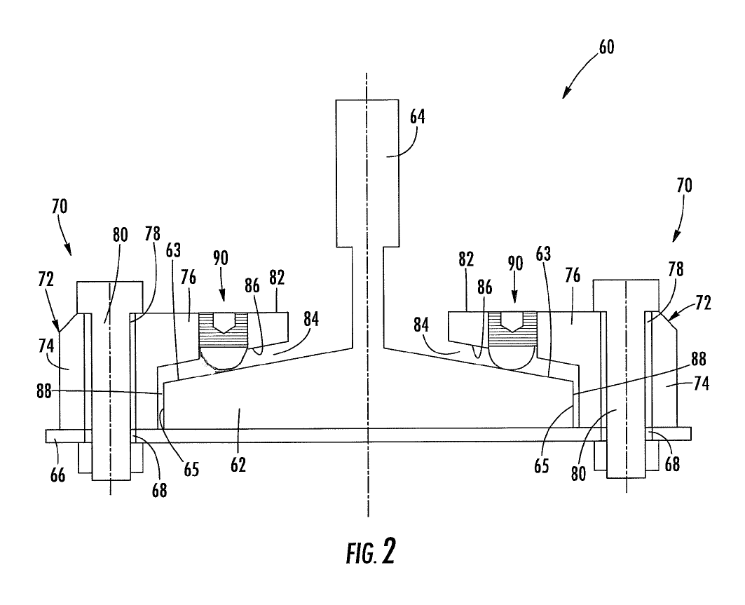

The elevator car and counterweight guide rails are formed in sections that are aligned vertically in an end to end assembly. With reference now to FIG. 2, an example of a guide rail section 60 is illustrated in more detail. As shown, the guide rail section 60 typically has a T-shaped cross-sectional configuration and includes a base flange 62 and a centrally positioned web or blade 64 that runs longitudinally along the length of the flange 62. As previously described, the elevator car 12 and the associated counterweight 22 are each configured to move freely along a pair of spaced apart guide rails via rollers or guide shoes that travel along the blade portion 64 of each rail.

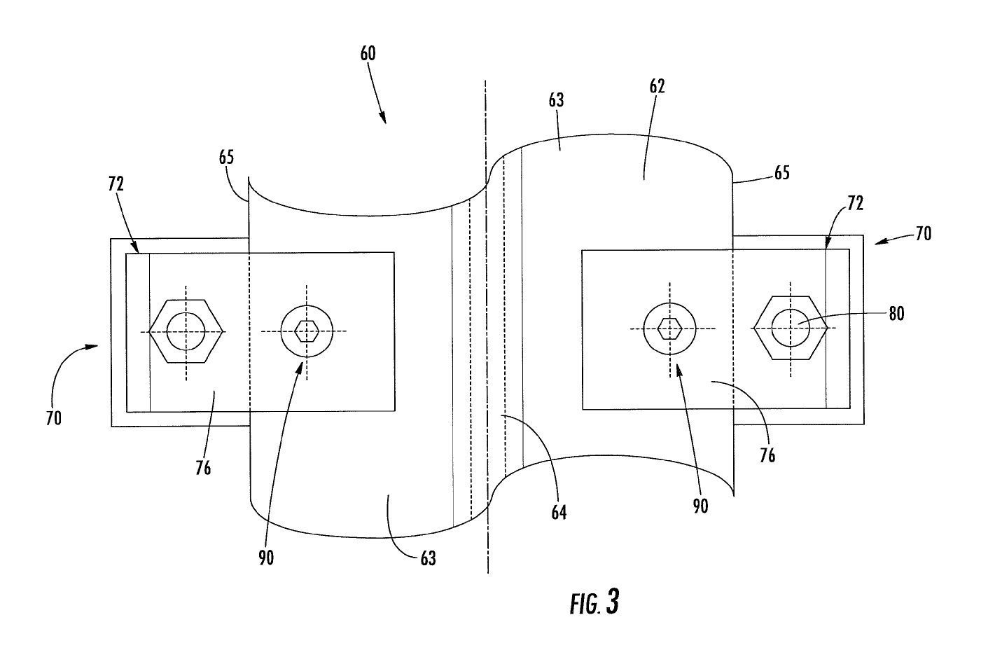

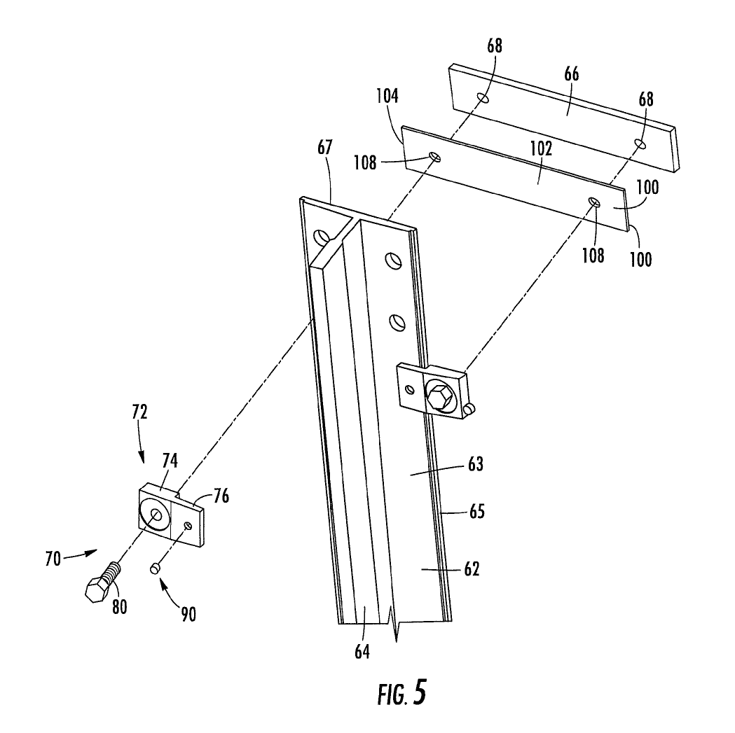

Each guide rail section 60 is attached to a plurality of support brackets 66 (best shown in FIG. 5) using one or more rail clip assemblies 70. Referring now to FIGS. 2-6, an example of a rail clip assembly 70 is illustrated in more detail. Each rail clip assembly 70 includes at least one rail clip 72. In the illustrated, non-limiting embodiment of the FIGS., the rail clip assembly 70 includes two rail clips 72.

Each rail clip 72 includes a base 74 adapted to contact a portion of the support bracket 66 adjacent the base flange 62 of the guide rail section 60. The base 74 extends generally parallel to the blade portion 64 of the guide rail section 60. An arm 76 mounted to the base 74 extends outwardly over a portion of the base flange 62 of the guide rail section 60. As shown, the arm 76 and the base 74 are integrally formed. However, embodiments where the arm 76 and base 74 are coupled to one another are also contemplated within disclosure. A bolt receiving hole 78 extends through the base 74 and is centered about a corresponding through hole 68 formed in the support bracket 66. In assembly, a bolt 80 is passed through the holes 78 and 68 to secure the rail clip 72 to the underlying support bracket 66. The hole 78 can be circular as shown, or may have another configuration to allow for some adjustment of the clip 74 in the assembly 70.

An upper surface 82 of the arm 76 is generally flat and is arranged parallel to the support bracket 66. As a shown, a gap 84 exists between a lower surface 86 of the arm 76 of the rail clip 72 and the base flange 62 of the guide rail section 60. For example, the arm 76 may be arranged generally parallel to the surface 63 of the base flange 62. In one embodiment, the lower surface 86 of the arm 76 adjacent the base flange 62 has a contour substantially identical or complementary to the base flange 62 such that the gap 84 is substantially uniform over the length of the arm 76. However, in other embodiments, the gap 84 may vary over the length of the arm 76, for example if the surface 86 is arranged at an angle to the base flange 62. A gap 88 additionally exists between the base 74 of the rail clip 72 and a side surface 65 of the base flange 62. The gap 88 between the base 74 and the base flange 62 may but need not be identical to the gap 84 between the arm 76 and the base flange 72.

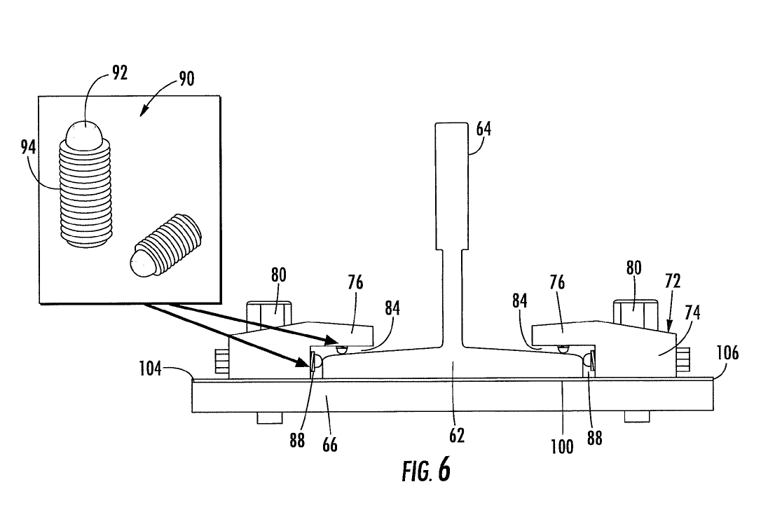

The rail clip 72 additionally includes at least one contact assembly 90 configured to project therefrom and contact a surface of the base flange 62. In one embodiment, illustrated in FIG. 2, the at least one contact assembly 90 projects vertically downward from the arm 76. Alternatively, or in addition, at least one contact assembly 90 may extend generally horizontally from a portion of the base 74 and contact the side surface 65 of the base flange 62. The contact assembly 90 includes a contactor 92 (see FIG. 6) arranged to contact an adjacent surface of the base flange 62 at a point. In one embodiment, the portion of the contactor 92 adjacent the base flange 62 has a spherical or rounded shape. For example, the contactor 92 may be a rolling ball. However, other configurations that achieve point contact between the contactor 92 and the base flange 62 are also within the scope of the disclosure. In addition, the contactor 92 may be formed from a material having high sliding properties, such as bronze for example.

In one embodiment, the contact assembly 90 additionally includes a biasing mechanism 94 and the contactor 92 may be mounted near an end of the biasing mechanism 94. In the illustrated, non-limiting embodiment, the biasing mechanism 94 is a coil spring and a fastener 96 (see FIG. 2) extending through a hollow portion of the coil spring is attached to the contactor 92; however, other types of biasing mechanisms 94, such as torsion springs or Belleville washers are also within the scope of the disclosure. The biasing force of the biasing mechanism 94 is configured to bias the contactor 92 into contact with and apply a force to an adjacent surface of the base flange 62. The fastener 96 may be used to create a pre-load in the biasing mechanism 94 such that a desired force is applied to the surface of the base flange 62 by the contactor 92.

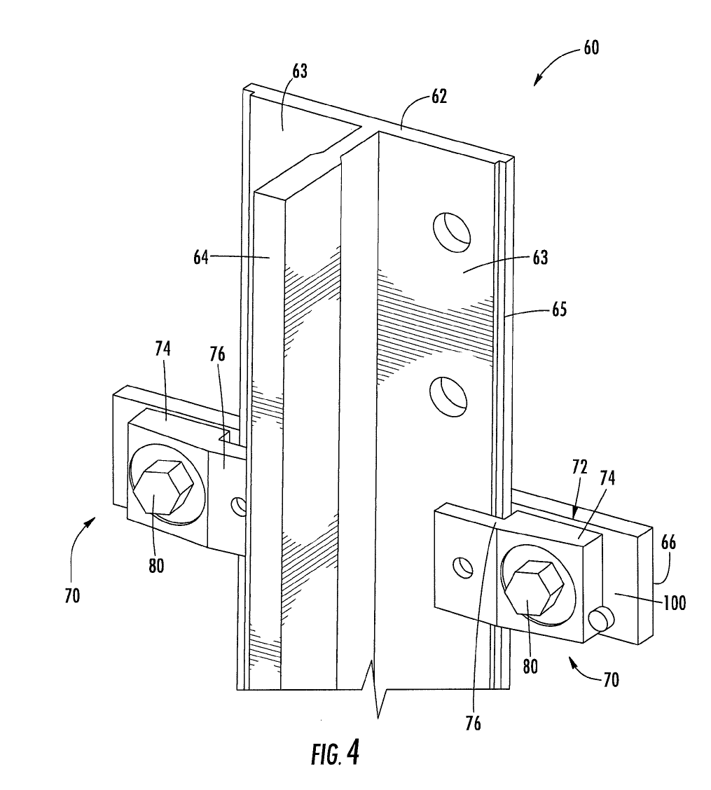

With reference now to FIGS. 4-6, in some embodiments, the rail clip assembly 70 additionally includes a base plate 100 disposed between both the guide rail section 60 and rail clips 72, and the support bracket 66. As shown, the base plate 100 includes a planar surface 102 configured to contact a portion of the guide rail section 60, such as a back surface 67 thereof for example. However, in embodiments where the back surface 67 of the guide rail section 60 has a non-planar configuration, a contour of the base plate 100 may be generally complementary to the corresponding portion of the guide rail section 60. In one embodiment, a contour of the base plate 100 is different than the guide rail section 60 such that the surface 102 is configured to contact the back surface 67 of the guide rail section 60 along a line.

The entire base plate 100, or the portion thereof configured to contact the guide rail section 60, may be formed from a material or may include a finish intended to reduce friction and improve the sliding properties of the guide rail section 60 relative to the base plate 100. In one embodiment, the portion of the base plate 100 arranged in contact with the guide rail section 60 includes a bronze material.

In addition, the base plate 100 is positioned such that a portion of the base plate 100 extends beyond at least one side of the guide rail section 60, for connection with the at least one rail clip 72. In the illustrated, non-limiting embodiment, the base plate 100 is generally rectangular and has a width greater than the guide rail section 60 such that a first end 104 of the base plate 100 extends beyond a first side 65 of the guide rail section 60 and a second end 106 of the base plate 100 extends beyond an opposite second side 65 of the guide rail section 60. The portion of the base plate 100 that extends beyond the guide rail section 60 includes a through hole 108 for receiving the bolt 80 configured to mount a rail clip 72 to the support bracket 66.

By contacting the guide rail section 60 via point contact, the rail clip assembly 70 reduces and in some instances cancels any vertical load applied to the rail through the brackets 66 and rail clip assembly 70. This cancelling of the vertical loads limits the rail size needed for an application, thereby reducing the hoistway space, complexity and cost. In addition, embodiments of the rail clip assembly 70 wherein the contactor assembly 90 includes a biasing mechanism 94 provides for easy adjustment of the pre-load in the biasing mechanism 94 in the field.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. A rail clip assembly for mounting a guide rail section to a support bracket, comprising:
a rail clip including a base and an arm extending at an angle to the base; and
at least one contact assembly mounted to the rail clip, wherein the contact assembly contacts an adjacent surface of the guide rail section at a point.

2. The rail clip assembly according to claim 1, wherein the contact assembly includes a contactor arranged in contact with the adjacent surface of the guide rail section, at least a portion of the contactor having a generally spherical shape.

3. The rail clip assembly according to claim 2, wherein the contact assembly further includes a biasing mechanism, the contactor being mounted at an end of the biasing mechanism such that the contactor is biased into contact with the adjacent surface of the guide rail section.

4. The rail clip assembly according to claim 3, wherein a fastener couples the contactor to the biasing mechanism and the fastener is configured to adjust a force applied by the contactor to the adjacent surface of the guide rail section.

5. The rail clip assembly according to claim 1, wherein the at least one contact assembly includes a contact assembly extending vertically from the arm.

6. The rail clip assembly according to claim 1, wherein the at least one contact assembly includes a contact assembly extending horizontally from the base.

7. The rail clip assembly according to claim 1, further comprising a base plate configured to mount between the guide rail section and the support bracket.

8. The rail clip assembly according to claim 7, wherein the base plate is configured to contact the guide rail section along a line.

9. A rail assembly, comprising:
a guide rail section including a base flange and a blade extending perpendicularly from the base flange;
a support bracket;
at least one rail clip assembly for mounting the guide rail section to the support bracket, the at least one rail clip assembly including:
a rail clip including a base and an arm extending at an angle to the base; and
at least one contact assembly mounted to the rail clip, wherein the contact assembly contacts an adjacent surface of the guide rail section at a point.

10. The rail assembly according to claim 9, wherein the base of the rail clip extends generally parallel to the blade of the guide rail section and the arm of the rail clip extends outwardly over a portion of the base flange.

11. The rail assembly according to claim 9, wherein a gap exists between the arm of the rail clip and an adjacent surface of the base flange.

12. The rail assembly according to claim 11, wherein the arm of the rail clip is arranged generally parallel to the adjacent surface of the base flange such that the gap is substantially uniform over a length of the arm.

13. The rail assembly according to claim 9, wherein a gap exists between the base of the rail clip and an adjacent surface of the base flange.

14. The rail assembly according to claim 9, wherein the at least one contact assembly includes a contact assembly extending vertically from the arm.

15. The rail assembly according to claim 9, wherein the at least one contact assembly includes a contact assembly extending horizontally from the base.

16. The rail assembly according to claim 9, wherein the contact assembly includes a contactor arranged in contact with the adjacent surface of the guide rail section, at least a portion of the contactor having a generally spherical shape.

17. The rail assembly according to claim 16, wherein the contact assembly further includes a biasing mechanism, the contactor being mounted at an end of the biasing mechanism such that the contactor is biased into contact with the adjacent surface of the guide rail section.

18. The rail assembly according to 17, wherein a fastener couples the contactor to the biasing mechanism and the fastener is configured to adjust a force applied by the contactor to the adjacent surface of the guide rail section.

19. The rail assembly according to claim 9, further comprising a base plate configured to mount between the guide rail section and the support bracket.

20. The rail assembly according to claim 19, wherein the base plate is configured to contact the guide rail section along a line.
